(19) United States
(12) Patent Application Publication
(10) Pub. No.: US 2004/0247368 A1
(43) Pub. Date: Dec. 9, 2004

(54) Suntan chamois

(76) Inventors: Kathy Dellanno, Atlantic Highlands, NJ (US); Paula M. Suida, Queens, NY (US)

Correspondence Address: Charles I. Brodsky, Esq., 2 Bucks Lane, Marlboro, NJ, 07746, US

(21) Appl. No.: 10/454,042

(22) Filed: Jun. 5, 2003

(51) Int. Cl. A46B 5/02; B08B 1/00

(52) U.S. Cl. 401/6; 15/104.93

(57) ABSTRACT

A chamois for applying suntan lotions, sunscreens and sunblocks to hard-to-reach areas of the body including a soft, pliable center section and a pair of side sections including one each of a pair of straps at opposite ends thereof for grasping in a user's hands to be operable by a sawing motion, and with the center section having a durable, synthetic fabric material which is semi-absorbent to receive suntan lotion, sunscreen and sunblock liquids directly sprayed or poured thereon as a cream or oil.

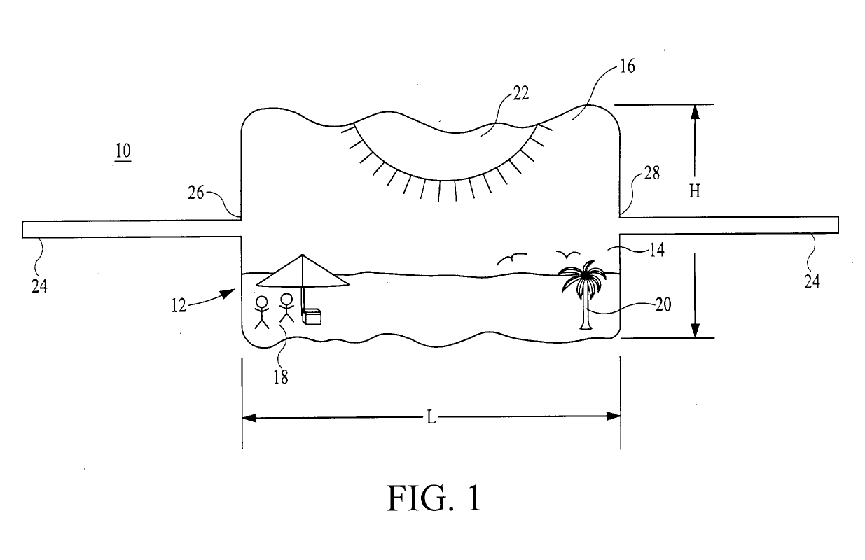

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to the protection of the skin from the harmful rays of the sun and, more particularly, to a chamois for applying suntan lotion, sunscreen and sunblock in hard-to-reach areas of the body.

2. Description of the Related Art

Background of the Invention

When laying in the sun—whether at the beach, in one's backyard, or poolside on a cruise ship—most people swab themselves with measured amounts of creams or oils so as to protect themselves against sunburn while allowing them to obtain a tan. With more and more research evidencing that too much sun can lead to skin cancer, an increasing awareness has come to be realized that not only should shorter intervals of time be spent exposed to the sun's rays, but that higher and higher spf numbers should be used for the suntan lotions, sunscreens and sunblocks being typically applied to afford the protection desired. However, no matter whether the cream or oil is sprayed or poured on the body and rubbed in for protection or for obtaining a tan, it is well appreciated that there exist certain parts of the body—and primarily the back—where the suntan lotion, sunscreen and sunblock is difficult to apply. In such circumstances, it is not unusual for the user to turn to his or her partner to ask for assistance in spraying or pouring the cream or oil on the back, and rubbing it into place. As will be understood, however desirable this may be, it is generally not possible to do when the user is alone, and where there is no one about to assist in applying such liquids to these hard-to-reach areas.

### OBJECTS OF THE INVENTION

It is an object of the present invention, therefore, to provide a user an alternative method of applying these suntan lotions, sunscreens and sunblocks in hard-to-reach areas alone, without the need to turn to another for assistance.

It is an object of the present invention, also, to provide such an alternative manner of application which is simple to use and inexpensive in cost.

It is another object of the present invention to provide such an alternative method of applying such creams and oils which can be easily utilized by young and by old, and by those who are hale-and-hearty, as well as by those whose flexibility is impaired.

### SUMMARY OF THE INVENTION

As will become clear from the following description, a chamois is provided according to the invention, for applying suntan lotions, sunscreens and sunblocks in hard to reach areas of the body. Such chamois will be understood to incorporate a soft, pliable center section having a durable, synthetic material on at least one of its front and rear opposing surfaces, which is semi-absorbent to the suntan lotion, sunscreen and sunblock liquid to be sprayed or poured thereon. Side sections including one each of a pair of straps are then included, at opposite ends of the center section, for grasping in a user's hands and operable to apply the suntan, sunscreen and sunblock liquid to the hard-to-reach areas of the back or otherwise, and by a sawing motion.

As will also be described, a preferred embodiment of the invention is one in which the center section of the chamois includes the durable, synthetic material on both of the front and rear opposing surfaces, with the synthetic material being washable. In this embodiment, a light-weight, durable synthetic material has the characteristics desired—and for ease of use, the straps are selected of an elasticized material. Such a chamois, incorporating these attributes, will be appreciated to be one which can be packaged for sale or distribution along with a dispenser containing suntan lotion, sunscreen or sunblock liquid, as a single unit—whether the liquid be in the form of a cream or oil. When so sold or distributed, the chamois and the included suntan lotion, sunscreen or sunblock liquid can, in accordance with the invention, be made available in a blister package of see-through plastic.

### BRIEF DESCRIPTION OF THE DRAWING

These and other features of the invention will be more clearly understood from a consideration of the following description, taken in connection with the sole figure of the drawing illustratively showing a chamois for applying suntan lotions, sunscreens and sunblocks in hard-to-reach areas of the body, according to the invention.

### DETAILED DESCRIPTION OF THE DRAWING

In the drawing, the chamois 10 includes a soft, pliable center section 12 having opposing front and rear surfaces 14, 16, at least one of which (and preferably both) includes a durable, synthetic material which is semi-absorbent to suntan lotion, sunscreen and sunblock liquids directly sprayed or poured thereon—and, either as a cream or oil. Decorated, for example, with a summer scene design as at 18, 20 or 22 (or any other design) in attractive colors on either or both of the opposing surfaces 14, 16, the center section 12 is joined with a pair of straps 24 serving as side sections of the chamois 10, at the opposite ends 26, 28 of the center section 12. Such straps are available for grasping in a user's hands, and are of a length to cooperate with the dimensions selected for the center section sufficient to apply the suntan lotion, sunscreen and sunblock liquid sprayed or poured on the front and/or rear surfaces 14, 16 to the back or other hard-to-reach areas of the body by a sawing motion—pulling on first one, and then the other of the straps. As such motion is analogous to that which is typically employed in toweling the body dry after showering or bathing, it is a motion generally used both by the young and by the old, by the healthy and by the frail, and is a motion which can be effective in applying the sprayed or poured creams or oils in almost an identical manner. After the suntan lotion, sunscreen and sunblock liquids have been applied to the body, the straps are then released for setting the chamois aside.

In a preferred embodiment of the invention, the synthetic material of the chamois is selected to be light-weight, thin and several times less heavy than a towel which a user might select to lie upon when sunning, or to dry off with after going into the ocean, lake, or swimming pool to cool off when the sun gets too strong. Not being thus too flimsy, or too bulky, a preferred construction for the center section 12 of the chamois 10 might be one of a length L of some 20 inches, and a height H of the order of 4 inches. The side-section straps 24 may be selected of any appropriate length when elasticized, so as to enable the chamois to be effectively used by those of all size—or can be dimensioned for small, medium, large, or extra-large size use when the straps 24 are not of an elastic material. With a neon color design for the scenes printed on the center section 12, the chamois of the invention can thus be made attractive for marketing—and when made of light-weight, durable, synthetic and washable fabric material, can simply be thrown into a washing machine or rinsed by hand to remove the liquid cream or oil after use, and then stored. By employing a durable synthetic material in this manner, the chamois will generally not wrinkle, but will retain its shape.

As will be appreciated by those skilled in the art, a chamois constructed according to the invention could be made available as a premium product, along with a dispenser containing suntan lotion, sunscreen or sunblock liquid, as a package for sale or distribution as a single unit. When so arranged, the chamois of the invention, along with the dispenser could be incorporated in a blister package of see-through plastic, and to be available for sale at a retail price well within the range of a typical purchaser. Based upon the chamois selected, the manufacturing cost of the package could be kept not very much greater than that of the suntan lotion, the sunscreen or the sunblock product itself, making a combined package especially attractive as a premium product.

While there has been described what is considered to be a preferred embodiment of the invention, it will be readily understood that modifications can be made without departing from the scope of the teachings herein of employing a chamois having a center section of semi-absorbent material to receive liquid creams or oils directly sprayed or poured thereon for application of suntan lotion, sunscreen or sunblock by a sawing motion when grasping the straps of its included side-sections. For at least such reason, therefore, resort should be had to the claims appended hereto for a clear understanding of the scope of the invention.

We claim:

1. A chamois for applying suntan lotions, sunscreens and sunblocks to hard-to-reach areas of the body, comprising:
a soft, pliable center section having a durable, synthetic material on at least one of the front and rear opposing surfaces thereof which is semi-absorbent to suntan lotion, sunscreen and sunblock liquids directly sprayed or poured thereon;
and a pair of side sections including one each of a pair of straps at opposite ends of said center section for grasping in a user's hands and operable to apply said suntan lotion, sunscreen and sunblock liquids to said hard-to-reach areas by a sawing motion, pulling on first one, and then the other of said pair of straps; and
with each of said straps being thereafter releasable for setting aside said chamois after said suntan lotion, sunscreen and sunblock liquids have been applied to the body.

2. The chamois of claim 1, wherein said soft, pliable center section includes said durable, synthetic material on both of said front and rear opposing surfaces.

3. The chamois of claim 1, wherein said pair of straps are each composed of an elasticized material.

4. The chamois of claim 2, wherein said center section is composed of a light-weight, durable synthetic material.

5. The chamois of claim 4, wherein said center section is composed of a washable fabric.

6. The chamois of claim 5, wherein said pair of straps are each composed of an elasticized material.

7. The chamois of claim 6 in combination with a dispenser containing suntan lotion, sunscreen or sunblock liquid, and in a package for sale or distribution as a single unit.

8. The chamois of claim 7 in a blister package of see-through plastic.
